(19) United States
(12) Patent Application Publication
(10) Pub. No.: US 2016/0230379 A1
(43) Pub. Date: Aug. 11, 2016

(54) Conveyor Belt Filter Device

(71) Applicant: Guido Frankenberger, Wetzlar (DE)

(72) Inventor: Guido Frankenberger, Wetzlar (DE)

(21) Appl. No.: 15/016,343

(22) Filed: Feb. 5, 2016

(30) Foreign Application Priority Data
Feb. 6, 2015 (DE) 102015001411.0

(51) Int. Cl. E03F 5/14; B01D 33/056; B01D 33/27; B01D 33/333

(52) U.S. Cl. CPC E03F 5/14; B01D 33/333; B01D 33/056; B01D 33/275

(57) ABSTRACT

A conveyor belt filter device for mechanically cleaning a liquid that flows in a sewer and is polluted with solids includes an endless filter belt formed by filter elements that are connected to one another and can be pivoted against one another. A frame having a lower frame portion for forming a lower filter belt conveying path within the sewer and an upper frame portion for forming an upper filter belt conveying path outside of the sewer supports the belt. The upper frame portion has a solids removal device in the area of an upper deflection device for removing solids adhering to the filter elements. The upper filter belt conveying path is arranged at an angle of inclination α relative to the lower filter belt conveying path.

### CROSS-REFERENCE TO RELATED APPLICATIONS

This application claims priority to German Patent Application No. 10 2015 001 411.0 filed on Feb. 6, 2015, which is fully incorporated herein by reference.

### STATEMENT REGARDING FEDERALLY SPONSORED RESEARCH OR DEVELOPMENT

Not applicable.

### FIELD OF THE INVENTION

The present invention relates to a conveyor belt filter device and to a sewer cleaning assembly.

### BACKGROUND OF THE INVENTION

Conveyor belt filter devices are used to mechanically clean a liquid that flows in a sewer and is polluted with solids and comprise an endless filter belt of sheetlike filter elements that are connected to one another and can be pivoted against one another, and a flexible drive means that is guided via a lower deflection device and at least one upper deflection device, and a frame that supports the deflection devices and the filter belt.

Conveyor belt filter devices of the kind mentioned above are also called pater-noster filter rakes and are primarily used to mechanically clean flowing sewage in sewers formed for this purpose. The sewage flows through the filter elements in the perpendicular or also in the longitudinal direction of the filter elements, and the filter elements carry the filtered matter, which cannot pass through the filter elements, out of the sewer.

In the area of an upper deflection device of the filter belt, which is arranged above the surface of the sewage, a scraper device of a solids removal device is provided, which is realized as a brush, for example, and removes filtered matter adhering to the filter elements from the filter elements before they reenter the liquid flowing through the sewer in the course of the circulation of the filter belt.

### SUMMARY OF THE INVENTION

The object of the present invention is to increase the effectiveness of the conveyor belt filter device while keeping the design of the conveyor belt filter device as compact as possible, as disclosed herein. It is particularly advantageous if the upper frame portion is provided with a lifting device for changing the distance of the deflecting section of the frame relative to the sewer bottom or for adjusting the angle of incidence.

### BRIEF DESCRIPTION OF THE DRAWINGS

In the following description, a preferred embodiment of the invention will be illustrated in more detail with the aid of the drawing. In the figures:

FIG. 1 shows a lateral view of a sewer cleaning assembly comprising a conveyor belt filter device;

FIG. 2 shows a top view of the conveyor belt filter device illustrated in FIG. 1; and

FIG. 3 shows a deflecting section of the conveyor belt filter device according to view III in FIG. 2.

### DETAILED DESCRIPTION OF THE EXAMPLE EMBODIMENTS

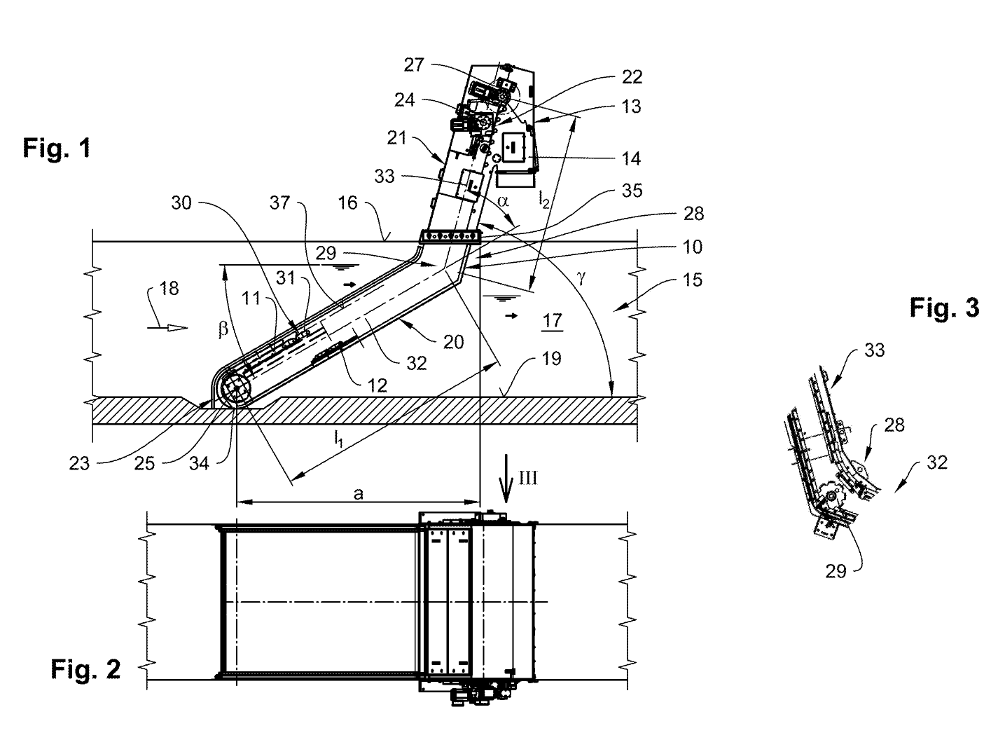

The conveyor belt filter device illustrated in FIG. 1 has a frame 10, a filter belt 11 guided on said frame 10, a chain drive 12 connected to said frame 10 and to said filter belt 11 and a filtered matter discharge 13 comprising a dropping sewer 14. The conveyor belt filter device is used to clean a sewer 15, which runs below an installation level 16 of the conveyor belt filter device. For this purpose, the filter belt 11 is provided with filter elements 30, which, in the present case, have a curved filter wall 31 formed by a perforated metal sheet.

A liquid 17 loaded with solids flows through the sewer 15 in a flow direction 18, which is illustrated by a directional arrow, wherein the sewer 15 may extend vertically to the drawing plane with extensive width. The conveyor belt filter device reaches down to a sewer bottom 19, thus blocking the entire flow cross-section of the sewer 15 transversely to the flow direction 18 and the liquid 17 having to pass through the part of the conveyor belt filter device that is located in the sewer 15.

The frame 10 is composed of a lower frame portion 20, which forms the part through which the liquid 17 has to pass, and of an upper frame portion 21, which extends largely outside of the sewer 15 and has an upper deflection device 22 at its upper end, which has an upper deflection shaft 24, which allows the filter belt to circulate 11 together with a lower deflection shaft 25 of a lower deflection device 23, which is arranged at the lower end of the lower frame portion 20, which is arranged within the liquid 17. In a deflecting section formed in the area of transition from the lower frame portion 20 to the upper frame portion 21, the upper frame portion 21 is inclined at an angle of inclination α relative to the lower frame portion 20 in such a manner that an upper filter belt conveying path 32 is arranged at the angle of inclination α relative to a lower filter belt conveying path 33. To deflect the filter belt, the deflecting section 28 has a deflection device 29, which is illustrated in particular in FIG. 3.

As shown in particular in FIG. 1, a solids removal device 27 is provided as part of the filtered matter discharge 13 at an upper end of the upper frame portion 21, said solids removal device being realized in the present case as a rotating scraper device, which scrapes solids off the filter elements 30 and transports them through the dropping sewer 14 to a solids receiving device (not illustrated).

As shown in FIG. 1, the conveyor belt filter device allows forming a sewer cleaning assembly, in which a frame base 34 of the lower frame portion 20 is supported on the sewer bottom 19 of the sewer 15 in the area of the lower deflection device 23 and a frame base 35 of the upper frame portion 21 is mounted on the installation plane 16 outside of the sewer 15 in such a manner that the distance a between the lower deflection device 23 and the upper deflection device 22 is smaller than the length l of a total conveying path 36, which is composed of the length l1 of the lower filter belt conveying path 33 and of the length l2 of the upper filter belt conveying path 32. This leads to a compact installation of the conveyor belt filter device above the sewer 15 in spite of a relatively flat angle of incidence α of the filter belt 11 and the resulting large effective filter surface 37.

Preferably, the upper frame portion 21 is provided with a lifting device 38 for changing the distance of the deflecting section 28 of the frame 10 relative to the sewer bottom 19.

1. A conveyor belt filter device for mechanically cleaning a liquid that flows in a sewer and is polluted with solids, said filter device comprising:
an endless filter belt formed by filter elements pivotally connected to one another and driven along a first conveyor path having a lower filter belt conveying path and an upper filter belt conveying path:
a lower deflection device and at least one upper deflection device guiding said endless filter belt along said first conveyor path;
a frame supportings the filter belt, the frame having a lower frame portion defining the lower filter belt conveying path and an upper frame portion defining the upper filter belt conveying path above said lower filter conveying path, the upper frame portion having a solids removal device proximal the upper deflection device for removing solids adhering to the filter elements, the upper filter belt conveying path being arranged at an angle of inclination α relative to the lower filter belt conveying path.

2. The conveyor belt filter device according to claim 1, including a deflection device arranged at a deflecting section of the frame to form the angle of inclination α proximal a transition between the lower filter belt conveying path and the upper filter belt conveying path.

3. The conveyor belt filter device according to claim 2, in which the upper frame portion pivots relative to the lower frame portion to adjust the angle of inclination α.

4. A sewer cleaning assembly comprising:
a conveyor belt filter device according to claim 1 and installed in a sewer, wherein a frame base of the lower frame portion is supported on a sewer bottom of the sewer proximal the lower deflection device, and a frame base of the upper frame portion is mounted on an installation plane outside of the sewer in such a manner that the distance a between the lower deflection device and the upper deflection device is smaller than the length l of the total conveying path, which is composed of the length l1 of the lower filter belt conveying path and of the length l2 of the upper filter belt conveying path.

5. The sewer cleaning assembly according to claim 4, in which the lower filter belt conveying path is arranged at an angle of incidence β between 15° and 45° relative to the sewer bottom and the upper filter belt conveying path is arranged at an angle of installation γ equal to β plus a relative to the sewer bottom on the installation plane.

6. The sewer cleaning assembly according to claim 5, in which the angle of incidence β is between 25° and 30°.

7. The sewer cleaning assembly according to claim 4, in which a deflecting section of the frame is arranged proximal an upper edge of the sewer.

8. The sewer cleaning assembly according to claim 4, in which a support supports the frame proximal a deflecting section on a sewer wall or on the installation plane.

9. The sewer cleaning assembly according to claim 4, in which the upper frame portion is provided with a lifting device for changing the distance of a deflecting section of the frame relative to the sewer bottom.
